(19) United States
(12) Patent Application Publication
(10) Pub. No.: US 2025/0050528 A1
(43) Pub. Date: Feb. 13, 2025

(54) HEATING TOOL

(71) Applicant: ZÜND SYSTEMTECHNIK AG, Altstätten (CH)

(72) Inventors: Darren COOMBS, Altstätten (CH); Juan GOMEZ SALINAS, Altstätten (CH)

(21) Appl. No.: 18/710,598

(22) PCT Filed: Nov. 16, 2022
(86) PCT No.: PCT/GB2022/052909

§ 371 Date: May 15, 2024

(30) Foreign Application Priority Data
Nov. 16, 2021 (GB) 2116478.5

(51) Int. Cl. B26D 7/10; B26D 7/27

(52) U.S. Cl. CPC B26D 7/10; B26D 7/27

(57) ABSTRACT

A heating tool for preparing a planar material for cutting, the heating tool includes an airflow generator for generating an airflow; a heater for heating the generated airflow; a flow director assembly configured to direct the heated airflow, wherein the flow director assembly is configured to move between a first configuration and a second configuration, wherein in the first configuration, the flow director assembly directs the heated airflow towards a heating target position and, in the second configuration, the flow director assembly directs the heated airflow away from the heating target position; and means for powering motion of the flow director assembly between the first configuration and the second configuration.

### TECHNICAL FIELD

The invention relates to heating tools for use in sealing a planar material, such as a composite material. The invention also relates to cutting systems and processes for planar materials.

### BACKGROUND

It is common to prepare a large piece of a planar material and then cut the piece into individual units according to required shapes and quantities. For example, this may be applied to a composite material, such as a woven material or textile.

However, cutting a planar material can cause weaknesses such as frayed edges or loose threads. In order to reduce this effect, the material may be sealed along an intended cutting pattern, usually before the cutting is performed (although it may also be sealed after cutting). For example, the material may be sealed using a chemical treatment, such as an adhesive, or using a heat treatment, such as a targeted heating tool.

In many targeted heating tools, a heating element takes a significant amount of time and energy to heat up and cool down. Additionally, an operating temperature of the heating element can be hot enough to damage some components of the tool unless adequate heat dissipation is provided. The combination of a high operating temperature and a non-instantaneous starting and stopping can mean that a continuous flow of heat from the heating element (for example using an air flow past the heating element) is necessary in order to preserve a lifespan of the tool. As a result, the tool cannot be conveniently stopped and started according to the requirements of an arbitrary cutting pattern.

In view of the above, it is desirable to provide a heating tool suitable for applying heat in an arbitrary pattern on a planar material.

### SUMMARY

According to a first aspect, this disclosure provides a heating tool for preparing a planar material for cutting, the heating tool comprising: an airflow generator for generating an airflow; a heater for heating the generated airflow; a flow director assembly configured to direct the heated airflow, wherein the flow director assembly is configured to move between a first configuration and a second configuration, wherein in the first configuration, the flow director assembly directs the heated airflow towards a heating target position and, in the second configuration, the flow director assembly directs the heated airflow away from the heating target position.

By providing such a flow director assembly, the heater can be operated continuously while activating and deactivating a heating effect at the heating target position. The second configuration could be referred to as a “standby” configuration, where the heating tool is ready to apply heat to the heating target position, without needing to restart the heater.

Even in cases where it is not necessary to continuously operate the heater, the flow director assembly may be advantageous for providing a sharp activation and deactivation of heating at the heating target position, without applying intermediate temperatures as the tool turns on or off. For example, after the heater is turned off, it may take a while before the flow of heated air completely stops. This may improve safety, as well as improving consistency of the heating effect.

In some embodiments, the flow director assembly comprises a receiving channel having an inlet, wherein the receiving channel is configured to move between a first receiving channel position for receiving the heated airflow at the inlet and a second receiving channel position away from the heated airflow.

With this configuration, the receiving channel can cool down while in the second receiving channel position, meaning that an average expected temperature of the receiving channel can be reduced, and a wider variety of materials are suitable.

The receiving channel may be connected to an exhaust channel for discarding the heated airflow. In this case, in the first configuration of the flow director assembly, the receiving channel is in the second receiving channel position, and in the second configuration of the flow director assembly, the receiving channel is in the first receiving channel position.

Discarding the heated airflow means that the heater can be operated continuously and a rise in internal temperature of the heating tool can be avoided while in the second configuration (when the heated airflow is not being used on the heating target position).

More specifically, the exhaust channel may comprise a mixing chamber for internally mixing the heated airflow with ambient air.

This may improve safety by reducing the temperature of the heated airflow before the airflow is discarded from the heating tool.

Additionally or alternatively, the receiving channel may be connected to a recycling channel for recycling the heated airflow through the heater. In this case, in the first configuration of the flow director assembly, the receiving channel is in the second receiving channel position and, in the second configuration of the flow director assembly, the receiving channel is in the first receiving channel position.

Recycling the heated airflow through the heater in the second configuration can improve energy efficiency. Recycling the heated airflow may in some cases be combined with reducing a power, current or voltage supplied to the heater in order to continue operating the heater while avoiding a rise in internal temperature of the heating tool.

Alternatively, the receiving channel may comprise an outlet directed towards the heating target position. In this case, in the first configuration of the flow director assembly, the receiving channel is in the first receiving channel position and, in the second configuration of the flow director assembly, the receiving channel is in the second receiving channel position.

In some embodiments, the flow director assembly comprises a directing channel having a nozzle that is configured to move between a first nozzle position for directing the heated airflow towards the heating target position and a second nozzle position for directing the heated airflow away from the heating target position. In this case, in the first configuration of the flow director assembly, the nozzle is in the first nozzle position and, in the second configuration of the flow director assembly, the nozzle is in the second nozzle position.

In some embodiments, the flow director assembly comprises a shutter configured to move between an open shutter position and a closed shutter position wherein, in the open shutter position, the heated airflow passes through the shutter and, in the closed shutter position, the heated airflow is deflected by the shutter. A shutter may be simpler to construct, operate and/or maintain when compared to a moveable channel or nozzle.

In some embodiments, the flow director assembly comprises an actuator for moving the heater between a first heater position and a second heater position, wherein a distance between the first heater position and the heating target position is smaller than a distance between the second heater position and the heating target position, and the first configuration comprises the first heater position and the second configuration comprises the second heater position.

By moving the heater, a distance between the heater and the heating target position can be reduced while heating, while still allowing adequate space for other components of the flow director assembly (such as a channel or shutter) while not heating the heating target position.

Preferably, the flow director assembly is biased to the second configuration. This means that, in the event of a failure such as a loss of power for controlling the configuration of the flow director assembly, the heating tool will fail safely into a configuration at which heat is not directed toward the heating target position.

According to a second aspect, the present disclosure provides a cutting system for a planar material, the system comprising: a heating tool according to the first aspect; a conveyor configured to move a piece of planar material and/or move the heating tool, such that the heating target position follows an intended cutting pattern on the piece of planar material; and a cutting tool configured to cut the piece of planar material along the intended cutting pattern.

In some embodiments, the cutting tool is the heating tool. For example, the heating tool may provide a heated airflow with sufficient temperature to simultaneously cut the planar material and seal an edge of the planar material.

According to a third aspect, the present disclosure provides a cutting method for a planar material, the method comprising: using a heating tool according to the first aspect, heating a piece of planar material along an intended cutting pattern; and using a cutting tool, cutting the piece of planar material along the intended cutting pattern.

In some embodiments, the cutting tool is the heating tool. For example, the heating tool may provide a heated airflow with sufficient temperature to simultaneously cut the planar material and seal an edge of the planar material.

### BRIEF DESCRIPTION OF THE DRAWINGS

FIGS. 1A, 1B and 1C are schematic perspective, plan and cross-section views of a heating tool according to a first embodiment;

FIGS. 2A to 2C are schematic views of the heating tool according to the first embodiment, moving from a standby configuration to an active configuration;

FIGS. 3A to 3C are schematic views of a heating tool according to a second embodiment;

FIG. 4 is a schematic block diagram of a cutting system according to an embodiment;

FIG. 5 is a schematic flow chart of a cutting method according to an embodiment;

### DETAILED DESCRIPTION

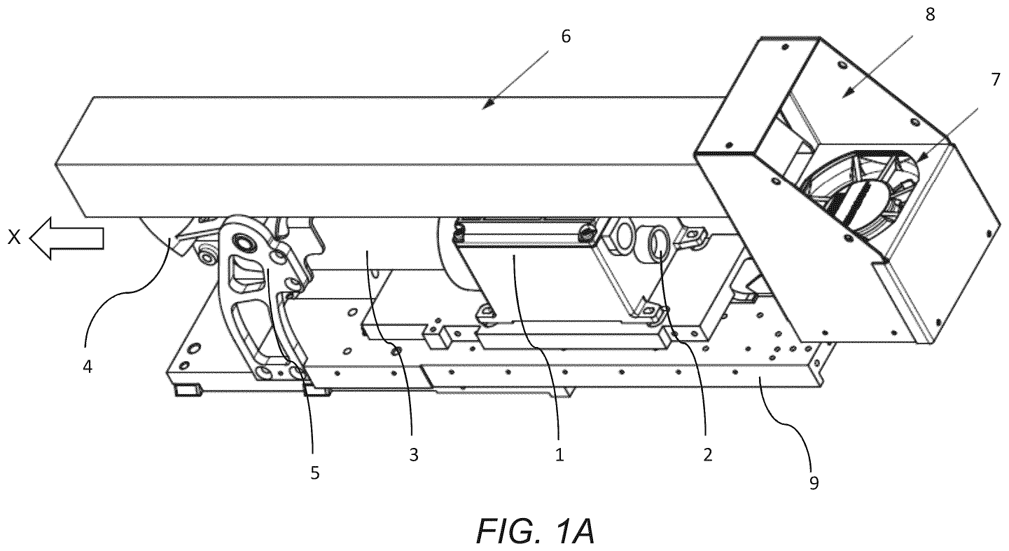

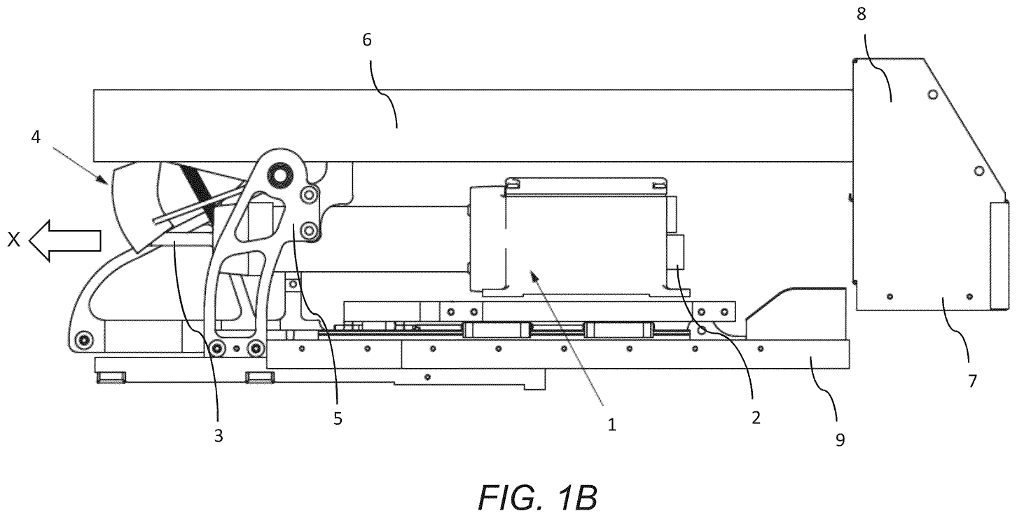

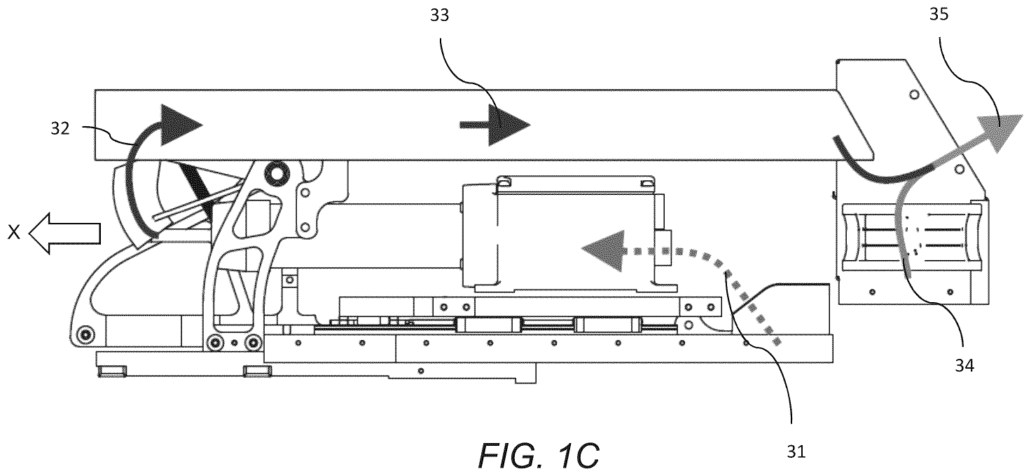

FIGS. 1A to 1C are schematic perspective, plan and cross-section views respectively of a heating tool according to a first embodiment. FIG. 1C additionally includes arrows illustrating air flow in the tool.

The heating tool comprises a heater 1 configured to receive an airflow, and heat the airflow as it passes through the heater. The airflow in this embodiment is generated by a compressed air supply (not shown) which feeds into inlet 2 of the heater 1, as indicated by the arrow 31 in FIG. 1C. Alternatively, the heater 1 may comprise an integrated airflow generator, such as an integrated fan or an integrated compressor, in which case the inlet 2 may be configured to receive uncompressed air (e.g. ambient air). The heater and airflow generator (e.g. compressed air supply) may be implemented using known components. The heating tool may, for example, provide a heated airflow at a temperature of at least 100° C., at least 200° C. or at least 400° C., and may provide the heated airflow at a temperature of less than 600° C. The compressed air supply may, for example, provide compressed air at between 2 and 8 bar and at a rate of between 200 and 600 I/min, preferably around 400 l/min.

The heated airflow is directed by a flow director assembly. When the heating tool is actively heating a target, the flow director assembly is in an active configuration (first configuration) in which the heated airflow is directed towards the heating target position (as illustrated by the arrow X). In one example, the heating tool may be oriented vertically above a target (i.e. the arrow X points downwards).

However, in the heating tool as shown in FIGS. 1A to 1C, the flow director assembly is in a standby configuration (second configuration) in which the flow director assembly directs the heated airflow away from the heating target position X. Preferably, in all embodiments, the flow director assembly is biased to the standby configuration (second configuration) so that, in the event of a loss of powered control, the flow director assembly reverts to the standby configuration under the power of one or more resilient elements (such as one or more spring mechanisms).

More specifically, the flow director assembly of this embodiment comprises a directing channel 3 with a fixed nozzle. The directing channel 3 is connected to the heater 1 to direct the airflow as it emerges from the heater 1. This directing channel 3 is aligned to direct the airflow towards the heating target position X.

The flow director assembly further comprises a moveable receiving channel 4. The receiving channel 4 is connected to a pneumatic rotating actuator 5 which is configured to rotate the receiving channel 4 between a first receiving channel position and a second receiving channel position.

As shown in FIG. 1A, when the receiving channel 4 is in the first receiving channel position, its inlet is aligned with the nozzle of the directing channel 3, and the airflow is redirected into an exhaust channel 6 for discarding the heated airflow, as shown using arrow 32.

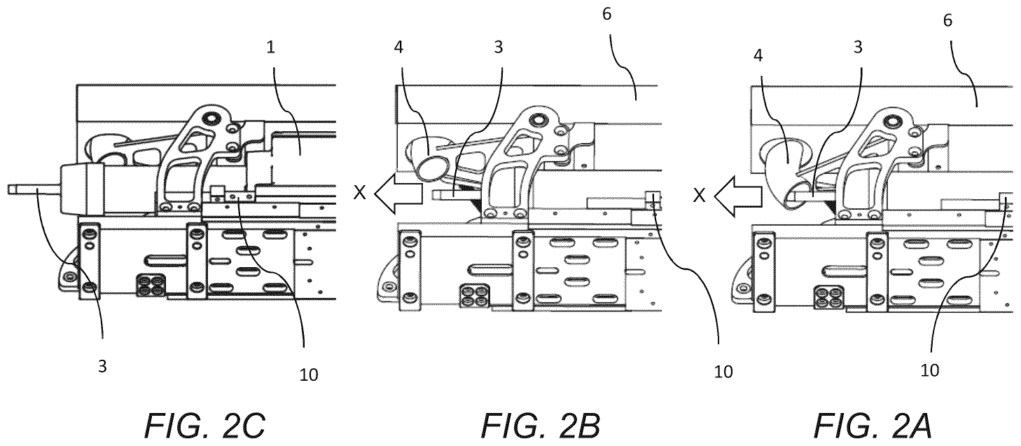

Referring now to FIGS. 2A to 2C, these are schematic views showing additional detail of the flow director assembly as it moves between the standby configuration and the active configuration.

In particular, FIG. 2A shows the receiving channel 4 in the first receiving channel position, as part of the standby configuration (second configuration), and FIG. 2B shows the receiving channel 4 in the second receiving channel position, as part of the active configuration (first configuration).

In the standby configuration (FIG. 2A), the inlet of the receiving channel 4 blocks the heated airflow from travelling out of the directing channel 3 towards the heating target position X, and instead redirects the heated airflow into the exhaust channel 6.

When the heating tool goes from the standby configuration to the active configuration, the pneumatic rotating actuator 5 moves the receiving channel 4 into a second receiving channel position (FIG. 2B) where the receiving channel 4 is away from the heated airflow, and the heated airflow can reach the heating target position X. Specifically, the receiving channel 4 in this example is partially within the exhaust channel 6 in the second receiving channel position.

A transition from the standby configuration to the active configuration may further comprise moving the heater 1. More specifically, as shown in FIGS. 2A to 2C, the heating tool may comprise a heater actuator 10 configured as a linear actuator for moving the heater 1 between a first heater position (FIG. 2C) and a second heater position (FIGS. 2A and 2B). In this example, the directing channel 3 is attached to the heater 1 and moves with the heater 1. This means that, in the active configuration (FIG. 2C) the heater 1 and a nozzle of the directing channel 3 are closer to the heating target position, and are able to deliver heat more effectively. On the other hand, in the standby configuration, the heater 1 is retracted to the second heater position so that the directing channel 3 can fit behind and direct airflow into the receiving channel 4.

It should be noted that while FIGS. 2A to 2C show an example transition from the standby configuration to the active configuration, a transition from the active configuration to the standby configuration may be the reverse of that described above, and is illustrated by viewing the figures from FIG. 2C to FIG. 2A.

In the above description of the flow director assembly, the pneumatic rotating actuator 5 is merely an example, and the receiving channel 4 can be moved along any path between the first receiving channel position and the second receiving channel position, with the motion powered by any means such as pneumatic power or a motor.

Referring again to FIGS. 1A to 1C, these figures show an embodiment of the standby configuration (second configuration) in which the receiving channel 4 connects with an exhaust channel 6. As shown in this example, this connection may simply be a connection between airflow in the receiving channel 4 and airflow in the exhaust channel 6 and does not require physical contact between the receiving channel 4 and the exhaust channel 6.

Once the heated airflow has entered the exhaust channel 6, the heated airflow is directed towards a mixing chamber 8, as illustrated by the arrow 33. As well as receiving air from the exhaust channel 6, the mixing chamber 8 is configured to receive a cold air source 7. The cold air source 7 may, for example, draw in room temperature air from outside the heating tool, and may draw air using a fan. The mixing chamber 8 allows the cold air source to mix with the heated airflow to produce cooled air. The cooled air is desirably cool enough to be safely released from the heating tool without posing a safety risk to any nearby operator. A maximum temperature of the cooled air may be controlled by controlling a rate of flow of the cold air source 7, and may be controlled automatically using a temperature sensor in the mixing chamber 8.

FIGS. 1A and 1B also illustrate a mounting bracket 9 for supporting the heating tool, for example when including the heating tool on an assembly line. The heating tool may further comprise a cold skin surrounding the heating tool. The cold skin is thermally insulated from components which become hot during operation (such as the heater 1 and the channels 3, 4, 6), so that an exterior of the heater tool is safe to touch during operation. The cold skin may be supported by one or more additional cooling elements such as fans arranged to drive air through or within the cold skin.

As one possible modification of the design in FIGS. 1A to 2C, FIGS. 3A to 3C are schematic perspective drawings illustrating part of an alternative flow director assembly. Although not fully shown, this alternative flow director assembly may again comprise a directing channel 3 and an exhaust channel 6.

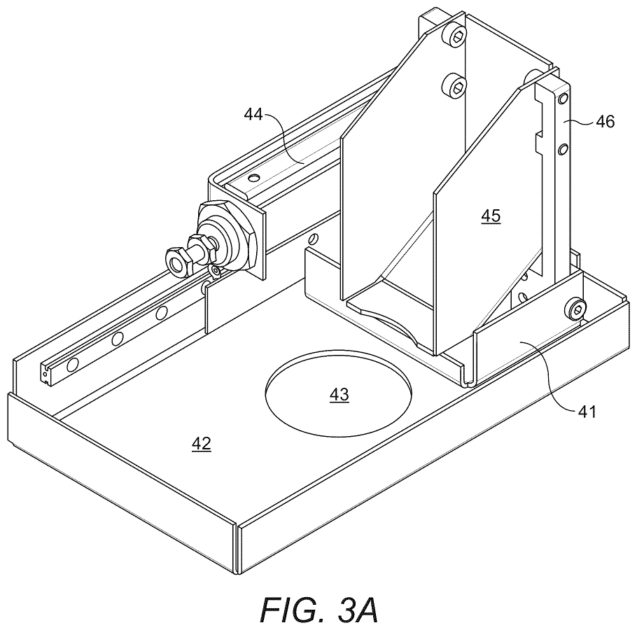

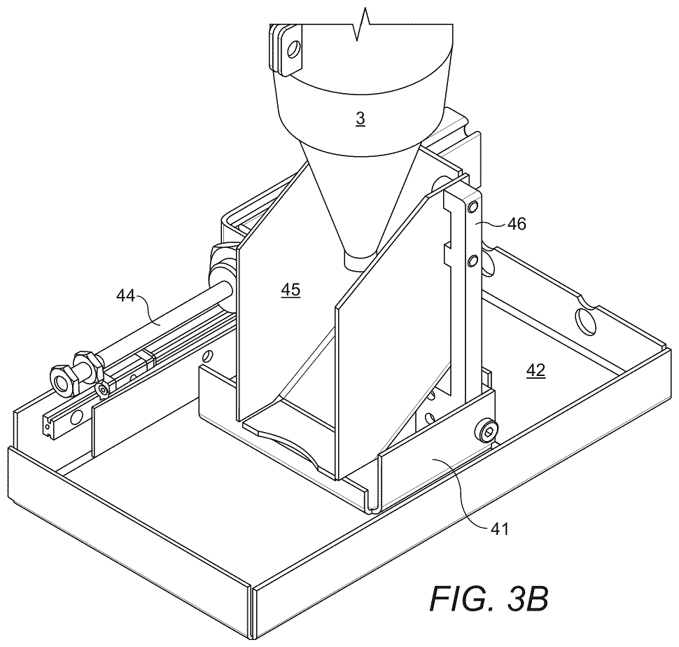

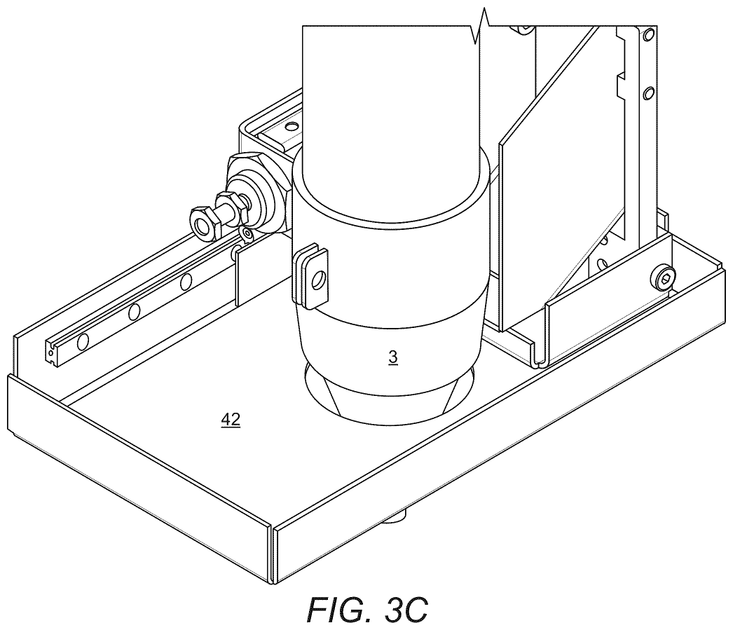

Referring to FIG. 3A, the alternative flow director assembly comprises a shutter assembly including a shutter 41 and a window plate 42 having a hole 43. When the shutter 41 is in an open shutter position, as shown in FIG. 3A, the heated airflow can pass through the hole 43. On the other hand, when the shutter 41 is in a closed shutter position, the shutter 41 blocks the hole 43.

The shutter assembly may for example comprise an actuator 44 configured to move the shutter between the open and closed positions. The actuator 44 may be a pneumatic actuator, and may guide the shutter 41 parallel to a rail.

The shutter 41 may comprise a deflection element 45 for deflecting the heated airflow away from the hole 43, and a cover 41 for covering the hole 43. The deflection element 45 may be separated from the cover 43 by a thermal insulator 46, so that the cover 41 is not directly heated by the heated airflow.

The shutter assembly may be arranged between the directing channel 3 and the heating target position, so that the deflection element 45 of the shutter can occupy a similar position to the receiving channel 4 in FIG. 1A.

In other words, when the shutter is in the closed shutter position as shown in FIG. 3B, the deflection element 45, together with the window plate 42, deflects the heated airflow into the exhaust channel 6. At the same time, as previously shown in FIGS. 2A and 2B, the heater 1 and directing channel 3 are in a second heater position, retracted away from the heating target position.

On the other hand, when the shutter is in the open shutter position as shown in FIGS. 3A and 3C, the heated airflow passes through the window plate 42 at the hole 43 and is directed towards the heating target position. Additionally, as previously shown in FIG. 3A, the heater 1 and directing channel 3 may be in a first heater position, extended toward the heating target position. As shown in FIG. 3C, a nozzle of the directing channel 3 may extend through the hole 43 of the shutter assembly.

Various other ways of implementing the flow director assembly are also envisaged.

For example, as a modification of the exhaust channel 6 and mixing chamber 8, the heated airflow could instead be recycled through the heater 1 through a secondary inlet in parallel with the inlet 2. With this configuration, the heat energy of the heated airflow can be retained in the standby state. Of course, without any outlet for this heat energy, the temperature of heater 1 would rise. To address this, in embodiments the exhaust channel 6 is replaced with a recycling channel, the power dissipated in the heater 1 could be reduced in the standby state, for example by reducing the voltage or power supplied to the heater 1. Nevertheless, the power supplied to the heater 1 can be matched to the power lost in order to maintain an operating temperature of the heater 1.

As another alternative, the directing channel 3 may be modified so that its outlet is directed away from the heating target position. For example, the directing channel 3 may be directed towards an inlet of the exhaust channel 6. In this case, the receiving channel 4 may comprise an outlet directed towards the heating position, and the receiving channel 4 may be moved to a position for receiving the heated airflow when the flow director assembly is in its active configuration and a position away from the heated airflow when the flow director assembly is in its standby configuration, contrary to the above examples.

As a further example, the directing channel 3 may have a nozzle section which can move relative to a main section. For example, the directing channel 3 may comprise a hinged section or a flexible section. The mobile nozzle may be configured to move between a first nozzle position for directing the heated airflow towards the heating target position and a second nozzle position for directing the heated airflow away from the heating target position. In other words, the mobile nozzle may be used as an addition or alternative to the receiving channel 4.

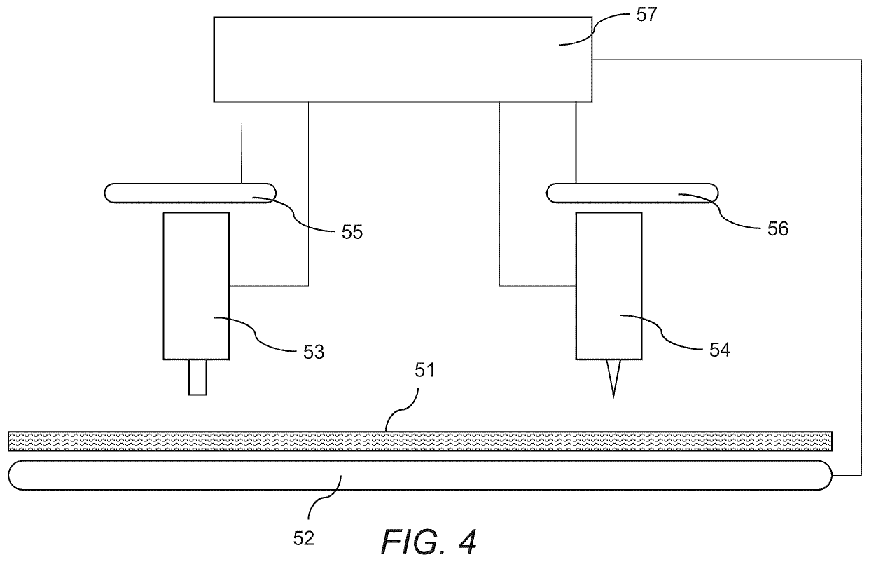

Any of the heating tools described above can be used as part of a cutting system. For example, FIG. 4 is a schematic block diagram of a cutting system for cutting a planar material 51.

Referring to FIG. 4 a piece of the planar material 51 is conveyed by a conveyor 52 along an assembly line. The planar material 51 may for example be a composite material. For example, the composite material may be a textile or a woven material. In one specific example, the composite material may be thermoplastic-reinforced fiberglass fabric.

The planar material 51 first passes under a heating tool 53. The heating tool 53 is arranged so that its heating target position is a position on the conveyor 52, such that when the planar material 51 passes it can be heated. As the conveyor 52 moves the planar material 51 relative to the heating tool 53, the heating target position follows an intended cutting pattern on the piece of planar material 51, and the cutting pattern is heat sealed in the planar material. The conveyor 52 may move the planar material 51 in two dimensions under the heating tool 53.

Additionally, the heating tool 53 may have its own conveyor 55 (for example a conveyor perpendicular to conveyor 52), and the two conveyors 52 and 55 may work together to provide two dimensional motion.

The planar material 51 then passes under a cutting tool 54. The cutting tool 54 is similarly arranged to cut the planar material 51 as it passes. As the conveyor 52 moves the planar material 51 relative to the cutting tool 54, the cutting tool 54 cuts the planar material 51 along the intended cutting pattern, and the edges of the cutting pattern experience reduced fray because they have been heat sealed by the heating tool 53. The conveyor 52 may move the planar material 51 in two dimensions under the cutting tool 54. Additionally, the cutting tool 54 may have its own conveyor 56 (for example a conveyor perpendicular to conveyor 52), and the two conveyors 52 and 56 may work together to provide two dimensional motion.

The tools 53, 54 and conveyors 52, 55 and 56 may be controlled by controller 57 which coordinates motion of the conveyors and activation of the tools.

More preferably, rather than providing two separate tool heads which both have to follow a cutting pattern, the heating tool 53 and the cutting tool 54 are mounted on a single head which is moved along the intended cutting pattern, such that the heating tool 53 and cutting tool 54 can operate almost simultaneously.

Yet further, the heating tool 53 may be operated as a cutting tool 54. More specifically, the heating tool 53 may be configured to melt the planar material 51 at the target heating position such that it breaks on either side of the cut, but at the same time the broken edges of the material 51 are sealed to reduce fraying.

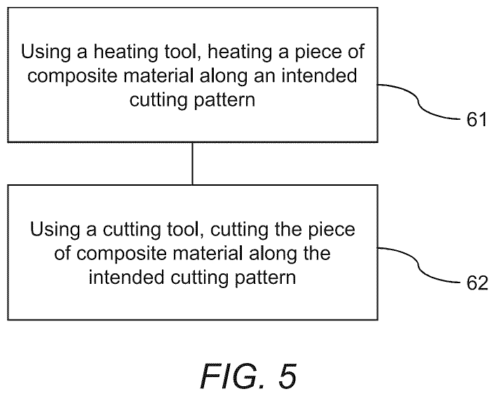

FIG. 5 is a schematic flow chart of a cutting method according to an embodiment. This corresponds to, for example, the system illustrated in FIG. 4. Step 61 comprises, using the heating tool 53, heating the piece of planar material 51 along the intended cutting pattern. Step 62 comprises, using the cutting tool 54, cutting the piece of planar material 51 along the intended cutting pattern.

1. A heating tool for preparing a planar material for cutting, the heating tool comprising:
an airflow generator for generating an airflow;
a heater for heating the generated airflow;
a flow director assembly configured to direct the heated airflow, wherein the flow director assembly is configured to move between a first configuration and a second configuration, wherein in the first configuration, the flow director assembly directs the heated airflow towards a heating target position and, in the second configuration, the flow director assembly directs the heated airflow away from the heating target position; and
means for powering motion of the flow director assembly between the first configuration and the second configuration.

2. The heating tool according to claim 1, wherein the flow director assembly comprises a receiving channel having an inlet, wherein the receiving channel is configured to move between a first receiving channel position for receiving the heated airflow at the inlet and a second receiving channel position away from the heated airflow.

3. The heating tool according to claim 2, wherein:
the receiving channel is connected to an exhaust channel for discarding the heated airflow,
in the first configuration of the flow director assembly, the receiving channel is in the second receiving channel position; and
in the second configuration of the flow director assembly, the receiving channel is in the first receiving channel position.

4. The heating tool according to claim 3, wherein the exhaust channel comprises a mixing chamber for internally mixing the heated airflow with ambient air.

5. The heating tool according to claim 2, wherein:
the receiving channel is connected to a recycling channel for recycling the heated airflow through the heater;
in the first configuration of the flow director assembly, the receiving channel is in the second receiving channel position; and
in the second configuration of the flow director assembly, the receiving channel is in the first receiving channel position.

6. The heating tool according to claim 2, wherein:
the receiving channel comprises an outlet directed towards the heating target position;
in the first configuration of the flow director assembly, the receiving channel is in the first receiving channel position; and
in the second configuration of the flow director assembly, the receiving channel is in the second receiving channel position.

7. The heating tool according to claim 1, wherein the flow director assembly comprises a directing channel having a nozzle that is configured to move between a first nozzle position for directing the heated airflow towards the heating target position and a second nozzle position for directing the heated airflow away from the heating target position,
in the first configuration of the flow director assembly, the nozzle is in the first nozzle position; and
in the second configuration of the flow director assembly, the nozzle is in the second nozzle position.

8. The heating tool according to claim 1, wherein the flow director assembly comprises a shutter configured to move between an open shutter position and a closed shutter position wherein, in the open shutter position, the heated airflow passes through the shutter and, in the closed shutter position, the heated airflow is deflected by the shutter.

9. The heating tool according claim 1, wherein the flow director assembly comprises an actuator for moving the heater between a first heater position and a second heater position, wherein a distance between the first heater position and the heating target position is smaller than a distance between the second heater position and the heating target position, and the first configuration comprises the first heater position and the second configuration comprises the second heater position.

10. The heating tool according to claim 1, wherein the flow director assembly is biased to the second configuration.

11. A cutting system for a planar material, the system comprising:
a heating tool comprising:
an airflow generator for generating an airflow;
a heater for heating the generated airflow;
a flow director assembly configured to direct the heated airflow, wherein the flow director assembly is configured to move between a first configuration and a second configuration, wherein in the first configuration, the flow director assembly directs the heated airflow towards a heating target position and, in the second configuration, the flow director assembly directs the heated airflow away from the heating target position; and
means for powering motion of the flow director assembly between the first configuration and the second configuration;
a conveyor configured to move a piece of planar material and/or move the heating tool, such that the heating target position follows an intended cutting pattern on the piece of planar material, and the heating tool seals the piece of planar material along the intended cutting pattern; and
a cutting tool configured to cut the piece of planar material along the intended cutting pattern.

12. The cutting system according to claim 11, wherein the cutting tool and the heating tool are mounted on a single tool head.

13. A cutting method for a planar material, the method comprising: using a heating tool comprising:
an airflow generator for generating an airflow;
a heater for heating the generated airflow;
a flow director assembly configured to direct the heated airflow, wherein the flow director assembly is configured to move between a first configuration and a second configuration, wherein in the first configuration, the flow director assembly directs the heated airflow towards a heating target position and, in the second configuration, the flow director assembly directs the heated airflow away from the heating target position; and
means for powering motion of the flow director assembly between the first configuration and the second configuration; heating a piece of planar material along an intended cutting pattern; and
using a cutting tool, cutting the piece of planar material along the intended cutting pattern.
